(19) United States
(12) Patent Application Publication
(10) Pub. No.: US 2002/0018270 A1
(43) Pub. Date: Feb. 14, 2002

(54) Method for adjusting the radiated power in a transmitter

(75) Inventor: Johannes Bozenhardt, Ettlingen (DE)

Correspondence Address: SUGHRUE, MION, ZINN, MACPEAK & SEAS, PLLC, 2100 Pennsylvania Avenue, NW, Washington, DC, 20037-3213, US

(73) Assignee: SIEMENS AG

(21) Appl. No.: 09/855,572

(22) Filed: May 16, 2001

Related U.S. Application Data
(63) Continuation of application No. PCT/DE99/03648, filed on Nov. 16, 1999.

(30) Foreign Application Priority Data
Nov. 16, 1998 (DE) 19852749.7
Nov. 30, 1998 (DE) 19855225.4

(51) Int. Cl. H04B 10/00; H04B 10/04

(52) U.S. Cl. 359/181; 359/154

(57) ABSTRACT

A method for adjusting the radiated power in a transmitter of a user station of an optical data transmission system. The user station is operable to generate an optical transmit signal (4) from a binary signal (1a), and transmit the optical transmit signal to another user station of the optical data transmission system. The transmitted signal (4) comprises light pulses that can be transmitted with a radiated power corresponding to a binary bit information. Using suitable measures, the radiated power can be adjusted in such a way, for example, that the service life of the transmitter is extended.

This is a Continuation of International Application PCT/DE99/03648, with an international filing date of Nov. 16, 1999, which was published under PCT Article 21(2) in German, and the complete disclosure of which is incorporated into this application by reference.

### FIELD OF THE INVENTION

The invention relates generally to a method for adjusting the radiated power in a transmitter, and more particularly to a method for adjusting the radiated power in a transmitter of a user station of an optical data transmission system. The user station is operable to generate an optical transmit signal from a binary signal and transmit the optical transmit signal to another user station of the optical data transmission system. The transmitted signal typically includes light pulses, which are transmitted with a radiated power corresponding to binary bit information “0” or bit information “1.”

### BACKGROUND OF THE INVENTION

Usually, bit information “0” of a binary signal to be transmitted is characterized by a low radiated power and is distinguished from bit information “1” which is characterized by a high radiated power. The low and high radiated powers are dimensioned in such a way that a receiver that receives alternating low and high powers can reliably decode the corresponding bit information “0” and “1” as originally represented in the binary signal.

During a given transmission of data, represented by a stream of alternating low (“0”) and high (“1”) pulses, bit information “1” may have to be transmitted over a relatively long transmission phase. In other words, the transmitter may be “ON” for an extended period of time. Consequently, particularly if a low-frequency binary signal is to be transmitted via an optical link, the probability that a sequence of light pulses with high radiated power must be transmitted is very high. The resulting extended “ON” time of the transmitter may, thus, cause an overload condition in the transmitter, which reduces the transmitter's service life. The service life of a transmitter is usually defined as the time span after which the radiated power, which is originally adjusted to a maximum, has dropped to fifty percent of the rated power.

According to a proposal by European Standard EN 60825, a user station of an optical transmission system, particularly a user station with light-emitting diodes of high output power, must be classified under laser protection class II-if no special protective measures are provided-since the radiated mean power exceeds a predefined limit within an observation interval (time interval) proposed by this standard. Consequently, the use of such stations in an optical data transmission system requires special safety measures for eye protection.

The reference EP 0 460 626 discloses a user station of an optical data transmission system, which is linked with other user stations in a ring-type optical data transmission line. The user stations are respectively provided with optical transmitters and receivers. Measures for adjusting the radiated power of the transmitter are not provided.

### OBJECTS OF THE INVENTION

An object of the present invention is to define a method of adjusting the power radiated from a transmitter in a simple manner. A further object is to create a user station of an optical data transmission system-operable to generate a transmitted signal from a binary signal, in which a transmitter of the user station can transmit to another user station through the optical data transmission system and wherein the transmitted signal comprises light pulses which can be transmitted at a radiated power corresponding to binary bit information-in which the transmitter's radiated power can be adjusted in a simple manner.

### SUMMARY OF THE INVENTION

With respect to the method, the above-mentioned objects are attained by providing a method for adjusting the radiated power of a transmitter of a user station of an optical data transmission system, wherein the user station generates a signal from a binary signal and transmits the signal to another user station of the optical data transmission system. Further, in accordance with an aspect of the invention, the transmitted signal includes light pulses, which are transmitted with a radiated power corresponding to binary bit information. Specifically, the method includes, determining a radiated mean power, respectively, within predefined time intervals, comparing the determined radiated power with a predefined limit value, and transmitting the light pulses of the transmitted signal within the time intervals at a radiated power level that does not exceed the predefined limit value.

The invention, according to another aspect, is also directed to a user station of an optical data transmission system is provided that is operable to generate a transmitted signal from a binary signal, wherein a transmitter of the user station transmits to another user station through the optical data transmission system and the transmitted signal includes light pulses that are transmitted at a radiated power corresponding to binary bit information. In accordance with this aspect of the invention, a user station is provided that includes a, power determining unit that determines the radiated mean power within predefined time intervals the radiated power of the transmitter. The power determining unit compares the determined radiated power with a predefined limit value and transmits the light pulses of the transmitted signal at a radiated power that does not exceed the limit value.

It is advantageous that, for instance, in a predefined optical transmission link, the useful life (service life) of the transmitter is increased by adjusting the radiated power to a predefined first limit, which is smaller than the power integral in an unmodulated transmission. The life of the transmitter is essentially determined by the sum of the radiated power over a certain time period.

In addition, for instance in fiber-optic data transmission systems, the usable cable length within the system can be increased for a predefined life of the transmitter. This is accomplished, for instance, by adjusting the radiated power to a predefined second limit, which corresponds to the maximum radiated power for which the manufacturer specifies the service life. The minimum radiated power that a receiver requires in order to be still able to detect bit information reliably is normally known from data sheets or based on suitable measurements. Further, the corresponding attenuation of the connectors and cables is known. Based on these known system quantities, it is possible, for a predefined service life of the transmitter, by a corresponding adjustment of the limit value, to increase the peak value of the radiated power without exceeding the technical limits. This makes it possible to increase the maximum distance over which the transmitted data can travel.

By adjusting the radiated power to a predefined limit as proposed by European Standard EN 60825, the need for special safety precautions for eye protection are avoided, and the user station does not need to be classified under laser protection class II.

By simple amplitude modulation of the binary information of the binary signal, a transmitted signal is generated such that the radiated mean power does not exceed the predefined limit value.

For producing the amplitude modulation, a modulation signal is provided, the modulation clock pulse of which is a multiple of the bit clock pulse of the binary signal, and which generates a modulated transmitted signal whose radiated power corresponds to n/2 times that of unmodulated light transmission.

Since a change in the bit information from “0” to “1” or from “1” to “0” in the binary signal is indicated by the radiated power in the modulated transmitted signal, which is greater than the maximum radiated power of unmodulated light transmission, it is extremely likely that a receiver of a user station of the optical data transmission system will be able to reliably decode the bit information (light/dark contrast).

### BRIEF DESCRIPTION OF THE DRAWINGS

The invention and further advantageous refinements of the invention are explained in more detail below with the aid of diagrammatic, exemplary embodiments in the drawing, in which:

FIGS. 1 and 2 show the time characteristic of a binary signal and of modulation signals; and

FIG. 3 shows a block diagram of a transmission unit.

### DETAILED DESCRIPTION OF THE PREFERRED EMBODIMENTS

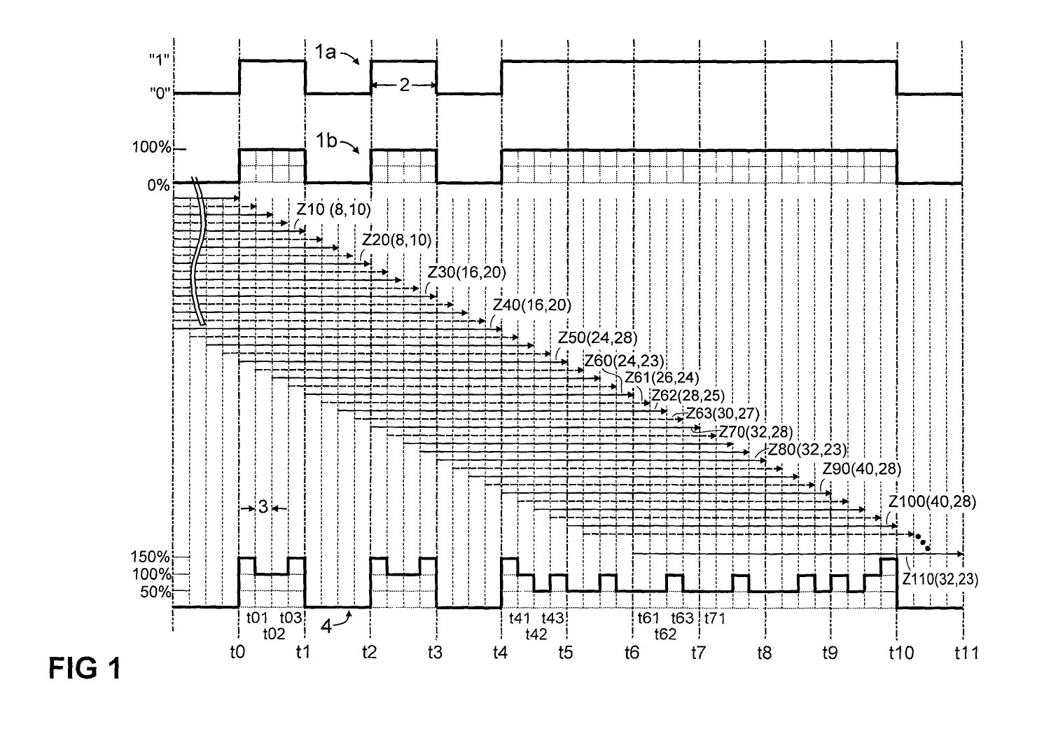

In FIG. 1, reference numeral 1a designates a binary signal, which has a bit clock pulse 2, bit information “0” and bit information “1.” From the binary information of the binary signal 1a, a user station of an optical data transmission system generates an amplitude-modulated transmitted signal 4 comprising light pulses to be transmitted to another user station of the data transmission system at a radiated power corresponding to bit information “0” and bit information “1.” The transmitted signal 4 comprises four radiated power levels of 0%, 50%, 100% and 150%, relative to a maximum value of a radiated power for unmodulated light transmission by the transmitting station. It is assumed here that bit information “1” is assigned to a group of radiated powers equal to or greater than 50%, while bit information “0” is assigned to a group of radiated powers of less than 50%. Based on this assignment, the receiving station is embodied in such a way that it is able to decode the bit information “0” and “1” from the received radiated power.

To illustrate the invention, the radiated power is represented in FIG. 1 by dashed squares within the transmitted signal 4, and within an unmodulated comparison signal 1b, which the transmitting station would generate in the case of unmodulated light transmission. For instance, in this case, the radiated mean power in the unmodulated light transmission of a bit information “1” includes eight radiation units integrated over a period of one bit clock pulse 2. This is shown by the eight dashed squares under the pulse shown in comparison signal 1b corresponding to bit clock pulse 2 of binary signal 1a.

In the present example, it is assumed that a time interval, Zij, i=1, 2, . . . , j=0, 1, 2, . . . , in which the radiated power may not exceed a predefined limit to ensure that the transmitter is not overloaded, corresponds to five bit clock pulses 2. Various intervals Zij can be seen in FIG. 1 as alternating dashed and solid arrows traversing sequential clock pulses, from t0, t1. . . . Modulated transmitted signal 4 has a modulation clock pulse 3 having a pulse width one-fourth (¼) that of bit clock pulse 2. Thus, a single time interval Zij comprises twenty modulation clock pulses 3.

Prior to an instant t0, the bit information is “0”. Thus, no light is transmitted, and the radiated power equals zero. At instant t0, the binary signal 1a changes its level from “0” to “1” where the level remains up to an instant t01. In the case of unmodulated data transmission during the time period from before t0 to t01, light would be transmitted with two radiation units up to said instant t01. The radiated power of transmitted signal 4 during this same period (before t0 to t01) is one and one half (1½) times the radiated power of unmodulated comparison signal 1b, i.e., with three radiation units. Due to this increased radiated power, improved dark/light contrast is produced in the receiving station, so that decoding of the transmitted signal is simplified with respect to the bit information. At instant t01, which is later than instant to by one modulation clock pulse 3, the instantaneous radiated power is reduced by one unit so that the radiated power of the transmitted signal 4 is equal to the corresponding instantaneous radiated power of comparison signal 1b. The radiated power in transmitted signal 4 remains constant from t01 up to an instant t03. Since a level change from “1” to “0” in the binary signal 1a is provided at an instant t1, the transmitted power of transmitted signal 4 is again increased during modulation clock pulse 3 in the period between instant t03and t1 by one and one half (1½) times the transmitted power of the comparison signal 1b. This, again, provides good light/dark contrast in the received signal. Up to instant t1, i.e., during time interval Z10, transmitted signal 4 transmits light to a user station with ten radiation units, i.e., light is transmitted with two more radiation units than in unmodulated light transmission, since the comparison signal 1b transmits light with eight radiation units. As shown in FIG. 1, the number of radiation units within a time interval Zij for unmodulated and modulated light transmissions is designated by an (“unmodulated,” “modulated”) identifier after the time interval Zij, i=1, 2, . . . , j=0, 1, 2, . . . “Unmodulated” denotes the number of radiation units of the light pulses of the unmodulated comparison signal 1b and “modulated” designates the number of radiation units of the light pulses of the transmitted signal 4. With respect to the example described above (before t0 to t1) the predefined limit of twenty-eight radiation units is not exceeded during the time interval (Z10(8, 10)).

Between instant t1 and an instant t2, bit information “0” must be transmitted, so that the sum of the radiated power of transmitted signal 4 remains constant at ten radiation units during time interval Z20 (8, 10).

In a time interval Z30(16, 20) the sum of the radiated power of the transmitted signal 4 increases to twenty radiation units, since ten radiation units are provided in the period between instant t2 and an instant t3, which is added to the ten radiation units provided in transmitted signal 4 between t0 and t1. In a time interval Z40(16, 20), up to an instant t4, the sum of the radiated power remains constant, since no light is transmitted in a period between instants t3 and t4.

During the period between instant t4, up to an instant t10, bit information in binary signal 1a is “1” and, thus, continuous light is to be transmitted during this time. At an instant t41 the radiated power of the transmitted signal 4 is, initially, one and one half (1½) times the radiated power of the unmodulated comparison signal 1b to obtain good light/dark contrast. Between instant t41 and an instant t42 the radiated power of the transmitted signal 4 is equal to the radiated power of unmodulated comparison signal 1b, and between instant t42 and an instant t43 the power is reduced to half that of signal 1b. Lastly, between instant t43 and an instant t5 the power is again raised to be equal to the radiated power of the unmodulated comparison signal 1b. As a result, in a time interval Z50(24, 28) the sum of the radiated power is increased. As shown, during the five clock interval up to instant t5, the radiated power rises to twenty-eight radiation units, which corresponds to the maximum predefined limit.

In the manner described above, the transmitting station generates transmitted signal 4 in the time intervals subsequent to t5 such that the radiated mean power does not exceed the predefined limit of twenty-eight radiation units. On the other hand, the radiated power of the unmodulated comparison signal 1b increases. For example, at an instant t62, during a time interval Z62(28, 25), the power reaches the predefined limit, and finally exceeds the limit at a subsequent instant t63. At instant t63, the radiated power of the unmodulated comparison signal 1b comprises thirty radiation units. The transmitted signal 4 comprises twenty-four radiation units at an instant t61, during time interval Z61(26, 24), twenty-five at instant t62 in time interval Z62(28, 25), twenty-seven radiation units at instant t63, during time interval Z63(30, 27), and twenty-eight radiation units at an instant t7, during time interval Z70(32, 28).

If the binary signal 1a is transmitted unmodulated—as described above—the radiated power of the comparison signal 1b exceeds the limit of twenty-eight radiation units as early as at instant t63, then rises to a maximum of forty radiation units up to an instant t9, during time interval Z90(40, 28), and then remains constant at this maximum power level from instant t9 up to instant t10. On the other hand, in the case of the modulation signal 4, the limit is not exceeded and the radiated power varies between twenty-three and twenty-eight radiation units from instant t63 until instant t10.

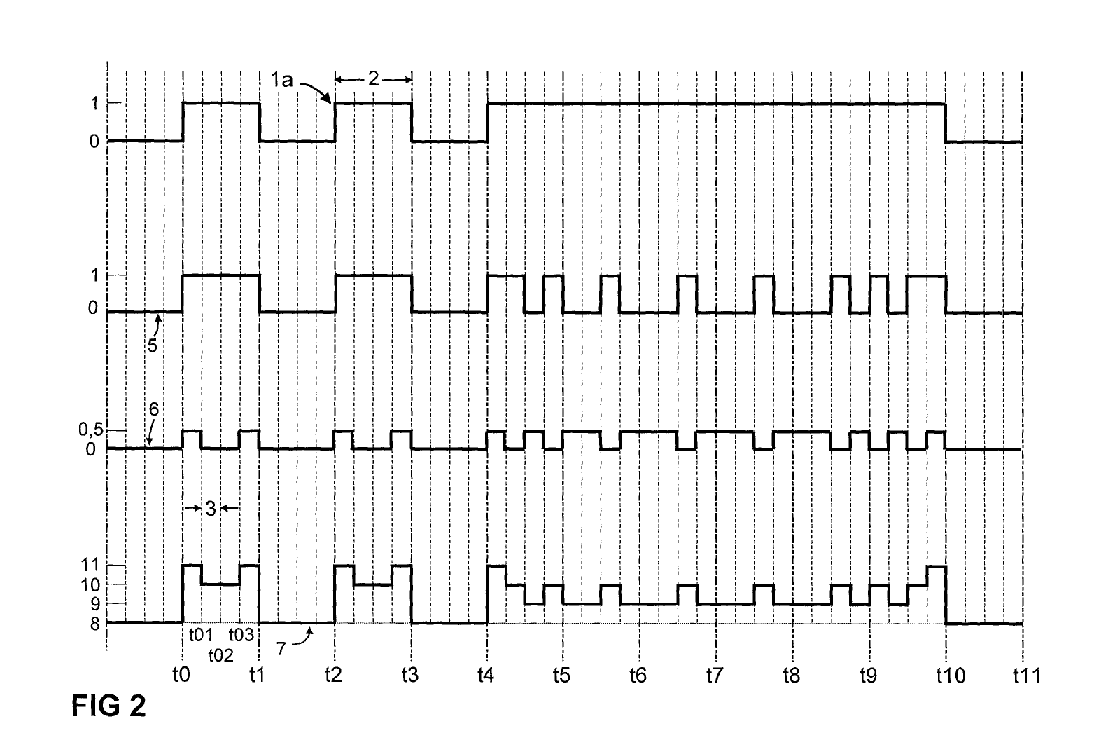

Reference is now made to FIG. 2, which illustrates representative time characteristics of a binary signal and various modulation signals. Portions of FIG. 2 that are analogous to similar portions -in FIG. 1 are provided with the same reference numbers.

In accordance with an embodiment of the present invention, a transmitting station initially generates a first and second modulation signal provided with modulation clock 3 (FIG. 1) in the form of a first and a second modulation current (5, 6 in FIG. 2), from which the user station, by summing these currents, forms a modulation current 7 for amplitude modulation of the binary data information of binary signal 1a. Modulation current 7 has four pulse heights 8, 9, 10, 11 and causes a current to flow through a transmission diode-which will be further discussed below. The modulation current 7 flowing through the transmission diode generates the modulated transmitted signal 4 (FIG. 1) which, corresponding to the four pulse heights 8, 9, 10, 11 of the modulation current 7, comprises four radiated power levels 0%, 50%, 100% and 150%, relative to a maximum value of the radiated power in unmodulated light transmission by the transmitting station. As described, the receiving user station assigns bit information “1” to a group of radiated powers equal to or greater than 50%, and bit information “0” to a group of output powers of less than 50%.

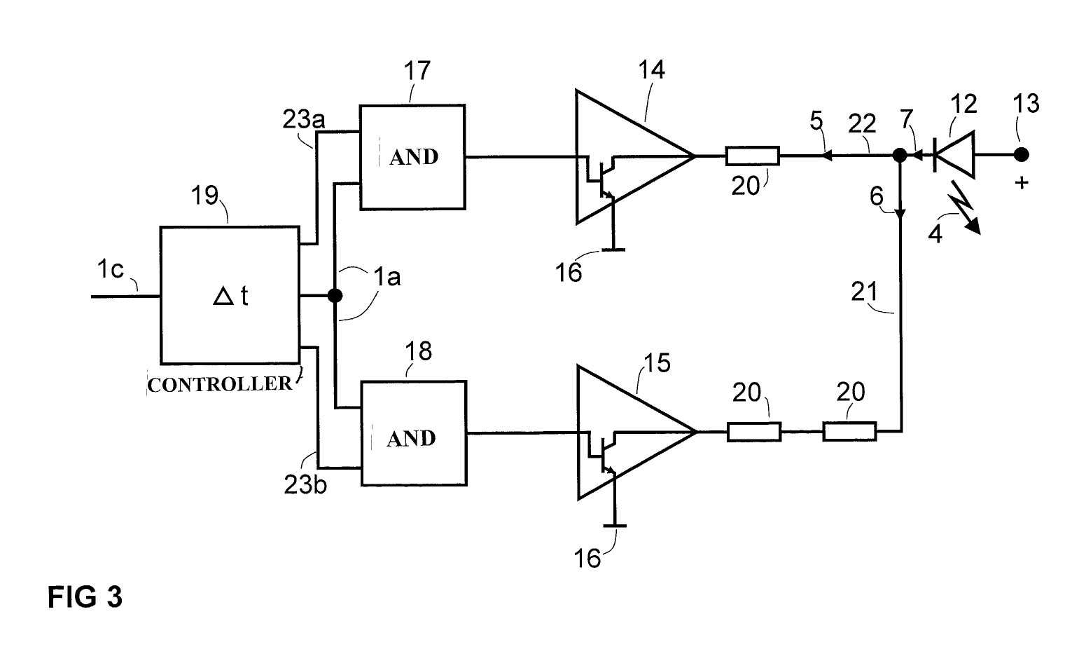

Reference is now made to FIG. 3, which shows a block diagram of a transmission unit (50) in accordance with one embodiment of the invention. The portions of FIG. 3 that are analogous to similar portions in FIGS. 1 and 2 are provided with the same reference numbers.

The transmission unit 50 includes, in particular, a transmitter in the form of a transmission diode 12, which is connected to a positive supply potential 13 and is linked via a first and a second driver stage 14, 15 to a frame potential 16. Other components of the transmission unit 50 are a first and a second AND gate 17, 18 and a power output control 19. In the power output control 19, the limit value which the radiated power is not to exceed within a time interval Zij, i=1, 2, . . . , j=0, 1, 2, . . . , (FIG. 1) and the duration of the time interval Zij, are adjustable. Further, a characteristic of the transmitter 12 can be stored in controller 19, which gives the relation between a modulation current 7 flowing through transmitter 12 and the radiated power of transmitter 12 effected by current 7. From this characteristic, and a binary signal 1c supplied to controller 19, controller 19 first determines the radiated mean power over a time interval for the case of unmodulated light transmission. If the radiated mean power is above the limit value, controller 19 generates a first and second binary release signal 23a, 23b having the modulation clock pulse 3 (FIG. 1), supplies the first release signal 23a to the first AND gate 17, the second release signal 23b to the second AND gate 18, and the binary signal 1a, which is time-shifted by a time interval At in relation to the binary signal 1c, to both AND gates 17, 18. In accordance with the level changes in the binary signal 1a and the predefined limit within the predefined time interval, the first and second driver stages, 14 and 15, are jointly or alternately released to effect a modulation current 7 with four pulse heights 8, 9, 10, 11 (FIG. 2), so that transmitter 12 emits a transmitted signal 4 with four radiated power levels of 0%, 50%, 100% or 150%.

As described above, in order to obtain good light/dark contrast, controller 19 takes into account the level changes in the binary signal 1a, e.g., at instants t0 and t1, so that a modulation current 7 flowing through transmitter 12 at instants t0 and t03 must be generated, which effects light transmission with a radiated power level of 150%. To this end, AND gate 18 activates the driver stage 15 at instants t0, t03 for the duration of a modulation clock pulse 3, so that the second modulation current 6 flows through a current path 21. Similarly, AND gate 17 activates driver stage 14 from instant t0 to instant t1, so that the first modulation current 5 flows through a current path 22. Due to the dimensioning of current path 22 with a resistor 20 and of current path 21 with two such resistors 20, the first modulation current 5 flows through current path 22 with a share of ⅔ and the second modulation current 6 flows through current path 21 with a share of ⅓ relative to the total current, i.e., relative to the modulation current 7. This means that the level of the first modulation current 5 corresponds to the level of a current flowing through transmitter 12 during unmodulated light transmission, while the level of the second modulation current 6 corresponds to half the level of the current flowing through transmitter 12 during unmodulated light transmission. Modulation current 7 flowing through transmitter 12 thus comprises one and one half (1½) times the level of the current flowing through the transmitter during unmodulated light transmission.

As described, in accordance with the level changes in the binary signal 1a and the predefined limit within the predefined time intervals, the driver stages 14, 15 are jointly or alternately released by release signals 23a and 23b to produce a modulation current 7, with four pulse heights 8, 9, 10, 11 (FIG. 2). Pulse height 8 corresponds to a level of 0, pulse height 9 corresponds to a level of one half, pulse height 10 corresponds to a level of one, and pulse height 11 corresponds to a level of one and one half, relative to a current flowing through the transmitter during unmodulated light transmission. This generates a transmitted signal 4 such that transmitter 12 emits light at four radiated power levels of 0%, 50%, 100% and 150% in relation to the maximum value of the radiated power in unmodulated light transmission.

The above description of the preferred embodiments has been given by way of example. From the disclosure given, those skilled in the art will not only understand the present invention and its attendant advantages, but will also find apparent various changes and modifications to the structures (and methods) disclosed. It is sought, therefore, to cover all such changes and modifications as fall within the spirit and scope of the invention, as defined by the appended claims, and equivalents thereof.

What is claimed is:

1. Method for adjusting the radiated power of a transmitter of a user station of an optical data transmission system, wherein the user station generates a signal from a binary signal and transmits the signal to another user station of the optical data transmission system, and wherein the transmitted signal comprises light pulses, which are transmitted with a radiated power corresponding to binary bit information, said method comprising:
determining a radiated mean power, respectively, within predefined time intervals,
comparing the determined radiated power with a predefined limit value, and
transmitting the light pulses of the transmitted signal within the time intervals at a radiated power level that does not exceed the predefined limit value.

2. A method as claimed in claim 1, further comprising:
amplitude modulating the binary data information of the binary signal over the predefined time intervals such that the radiated power of the transmitted signal does not exceed the predefined limit value within the predefined time intervals.

3. A method as claimed in claim 2, wherein said amplitude modulation comprises providing a modulation signal with a modulation clock pulse that has a predefined limit rate that is an integer multiple of a rate of the bit clock pulse of the binary signal.

4. A method as claimed in claim 2, wherein the modulation signal from the binary data information of the binary signal is used to generate a modulated transmitted signal with a radiated power corresponding to n/2 times a radiated power of a corresponding unmodulated light transmission, where n is an integer equal to or greater than zero.

5. A method as claimed in claim 4, wherein a change in a state of the bit information in the binary signal is indicated by the radiated power in the modulated transmitted signal, and wherein the radiated power in the modulated transmitted signal is greater than a maximum radiated power of the unmodulated light transmission.

6. A user station of an optical data transmission system operable to generate a transmitted signal from a binary signal, wherein a transmitter of the user station transmits to another user station through the optical data transmission system and the transmitted signal comprises light pulses which are transmitted at a radiated power corresponding to binary bit information, said user station comprising:
a power determining unit that determines the radiated mean power within predefined time intervals and adjusts the radiated power of the transmitter,
wherein the power determining unit compares the determined radiated power with a predefined limit value and transmits the light pulses of the transmitted signal at a radiated power that does not exceed the limit value.

7. A user station as claimed in claim 6, wherein the power determining unit amplitude-modulates the binary data information of the binary signal over the predefined time intervals such that the radiated power does not exceed the predefined limit within the time intervals.

8. A user station as claimed in claim 7, wherein the power determining unit generates a modulation signal whose modulation clock pulse rate is an integer multiple of the bit clock pulse rate of the binary signal.

9. A user station as claimed in claim 7, wherein the modulation signal generates a modulated transmitted signal from the binary data information of the binary signal whose radiated power corresponds to n/2 times the unmodulated light transmission, where n is an integer equal to or greater than zero.

10. A user station as claimed in claim 9, wherein the power determining unit modulates the binary data information of the binary signal such that a change in the binary bit information in the binary signal is indicated by raising the radiated power in the modulated transmitted signal to a level higher than the maximum radiated power of the unmodulated light transmission.

11. An optical transmission system comprising:
a binary signal generator operable to generate a binary signal representing data to be transferred over an optical link;
an optical transmitter operable to convert the data represented in said binary signal into corresponding pulses of light and transmit said pulses of light over the optical link;
an amplitude modulator operable to generate a modulation signal to regulate a radiated power of said pulses of light; and
an optical receiver operable to receive said pulses of light from said optical link,
wherein upon modulation of the power of said pulses of light, a mean radiated power, measured over a predefined interval of time, is maintained to be less than a maximum allowable power level.

12. An optical transmission system in accordance with claim 11, wherein an instantaneous power of said pulses of light is controlled to be equal to one of at least two discrete power levels during a radiating interval.

13. An optical transmission system is accordance with claim 12, wherein the instantaeous power of said pulses of light is higher at boundary edges of said pulses of light than at any other point during a transmission of the pulses of light.

14. An optical transmission system is accordance with claim 13, wherein said boundary edges of said pulses of light have a width approximately equal to a pulsewidth of a modulation clock pulse, wherein said modulation clock pulse is used to modulate an amplitude of said light pulses.
